(19) United States
(12) Patent Application Publication
(10) Pub. No.: US 2023/0127627 A1
(43) Pub. Date: Apr. 27, 2023

(54) METHOD OF RECOMMENDING DIAGNOSTIC TEST FOR USER EVALUATION

(71) Applicant: RIIID INC., Seoul (KR)

(72) Inventors: Kyu Seok KIM, Seoul (KR); Min Sam KIM, Seoul (KR)

(73) Assignee: RIIID INC., Seoul (KR)

(21) Appl. No.: 17/973,320

(22) Filed: Oct. 25, 2022

(30) Foreign Application Priority Data
Oct. 26, 2021 (KR) 10-2021-0143136

(51) Int. Cl. G09B 7/02

(52) U.S. Cl. CPC G09B 7/02

(57) ABSTRACT

The present disclosure relates to a method of recommending a diagnostic test question for user evaluation by an electronic device, including: generating a first matrix indicating whether users answer all questions correctly; generating a second matrix based on the first matrix using knowledge tracing (KT); and selecting the diagnostic test question using Lasso regression based on the second matrix.

### CROSS REFERENCE TO RELATED APPLICATION

This application claims priority to and the benefit of Korean Patent Application No. 10-2021-0143136, filed on Oct. 26, 2021, the disclosure of which is incorporated herein by reference in its entirety.

### BACKGROUND

### 1. Field of the Invention

The present disclosure relates to a method of constructing a diagnostic test to evaluate a user’s skill and creating a predictive model for the diagnostic test.

### 2. Discussion of Related Art

In the field of edutech technology, as a transformer-based model for user knowledge tracing (KT), an all-item KT model is generally used. The KT model is a machine learning (ML) model that determines knowledge levels of students and predicts the probability that students answer unsolved questions correctly based on the determined knowledge levels.

As a feature selection methodology that may be used in such a ML model, there is Lasso regression, which is a methodology for removing the weights of less important features. By using this methodology, it is possible to implement an ML model in which several features are missing.

Linear regression is a methodology that approximates a distribution of given training data with a linear function. By this methodology, it is possible for the ML model to perform training to find a shape similar to the generated linear graph.

### SUMMARY OF THE INVENTION

The present disclosure is directed to providing a configuration for recommending a diagnostic test for evaluating students.

In addition, the present disclosure is directed to solving a problem that prediction accuracy of an artificial intelligence model is lowered when the artificial intelligence model for predicting students’ scores is trained using a small sequence size.

The technical objects to be achieved by the present disclosure are not limited to the technical objects described above, and other technical objects that are not described may be clearly understood by those with ordinary knowledge in the technical field to which the present disclosure belongs from the following description.

According to an aspect of the present disclosure, there is provided a method of recommending a diagnostic test question for user evaluation by an electronic device, including: generating a first matrix indicating whether users answer all questions correctly; generating a second matrix based on the first matrix using knowledge tracing (KT); and selecting the diagnostic test question using Lasso regression based on the second matrix.

The first matrix may be a sparse matrix, and the second matrix may be a dense matrix.

The method may further include training a model for predicting a user’s score using linear regression based on the diagnostic test question.

The method may further include correcting a model for predicting the user’s score by using a time value taken for the user to solve the questions as a weight.

The time value may be an average value of times taken to solve questions for each part of the questions.

The time value may be a ranking value of the user compared to an average value of other users based on the average value.

According to another aspect of the present invention, there is provided an electronic device for recommending a diagnostic test question for user evaluation, including: a communication module configured to communicate with a terminal; a memory; an artificial intelligence (AI) processor; and a diagnostic test selection unit, in which the AI processor may generate, through the memory, a first matrix indicating whether users answer all questions correctly, and the diagnostic test selection unit may use KT to generate a second matrix based on the first matrix, and select the diagnostic test question using Lasso regression based on the second matrix.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram for describing an electronic device related to the present disclosure;

FIG. 2 is a block diagram of a system for recommending a diagnostic test to which the present disclosure may be applied;

FIG. 3 illustrates an embodiment of the electronic device to which the present disclosure may be applied;

FIG. 4 illustrates an example of a sparse interaction matrix to which the present disclosure may be applied;

FIG. 5 illustrates an example of a question selection to which the present disclosure may be applied; and

FIG. 6 illustrates an example of score prediction to which the present disclosure may be applied.

The accompanying drawings, which are included as part of the detailed description to help understanding of the present disclosure, provide embodiments of the present disclosure, and explain technical features of the present disclosure together with the detailed description.

### DETAILED DESCRIPTION OF EXEMPLARY EMBODIMENTS

Hereinafter, exemplary embodiments of the present disclosure will be described in detail with reference to the accompanying drawings. The same or similar components will be denoted by the same reference numerals regardless of the drawing numerals, and an overlapping description for the same or similar components will be omitted. In addition, terms “module” and “unit” for components used in the following description are used only to easily write the disclosure. Therefore, these terms do not have distinct meanings or roles by themselves. In addition, in describing the embodiment disclosed in the present disclosure, if it is determined that a detailed description of the related known art may obscure the gist of the embodiment disclosed in the present disclosure, the detailed description thereof will be omitted. Further, it should be understood that the accompanying drawings are provided only in order to allow exemplary embodiments of the present disclosure to be easily understood, and the spirit of the present disclosure is not limited by the accompanying drawings, but includes all the modifications, equivalents, and substitutions included in the spirit and the scope of the present disclosure.

Terms including ordinal numbers such as “first,” “second,”, and the like, may be used to describe various components. However, these components are not limited by these terms. The terms are used only to distinguish one component from another component.

It is to be understood that when one element is referred to as being “connected to” or “coupled to” another element, it may be directly connected or coupled to another element or connected or coupled to another element, having still another element intervening therebetween. On the other hand, it should be understood that when one element is referred to as being “directly connected to” or “directly coupled to” another element, it may be connected or coupled to another element without another element interposed therebetween.

Singular forms are intended to include plural forms unless the context clearly indicates otherwise.

It will be further understood that terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

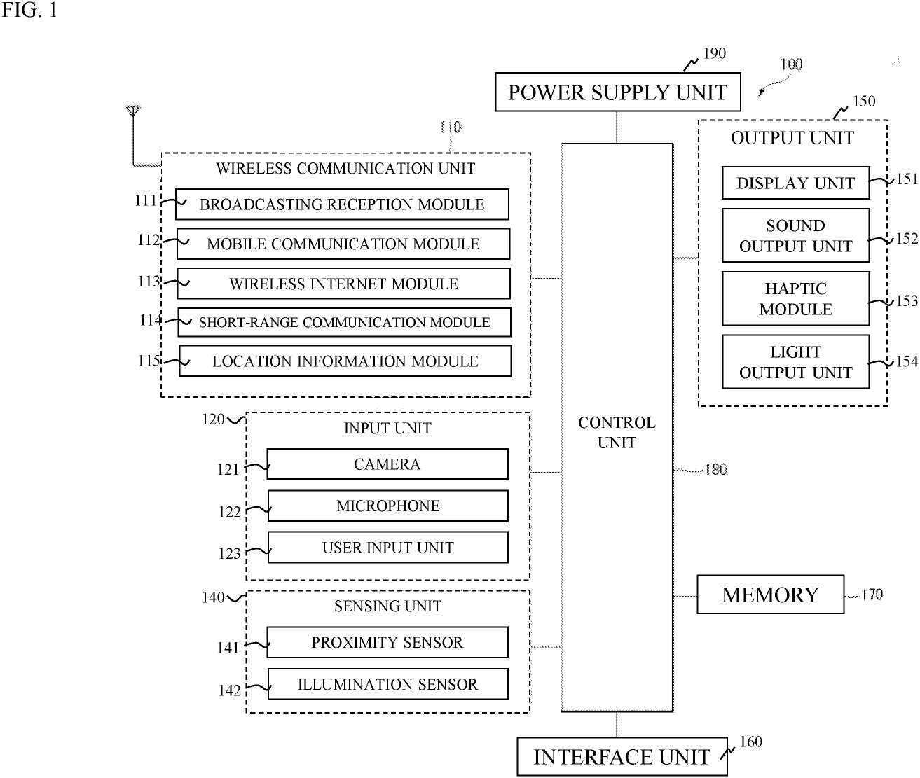

FIG. 1 is a block diagram for describing an electronic device related to the present disclosure.

An electronic device 100 includes a wireless communication unit 110, an input unit 120, a sensing unit 140, an output unit 150, an interface unit 160, a memory 170, a control unit 180, and a power supply unit 190, and the like. The components illustrated in FIG. 1 are not essential for implementing an electronic device, and the electronic devices described herein may have more or fewer components than those listed above.

More specifically, the wireless communication unit 110 of the components may include one or more modules which allow wireless communication between the electronic device 100 and a wireless communication system, between the electronic device 100 and other electronic devices 100, or the electronic device 100 and an external server. In addition, the wireless communication unit 110 may include one or more modules which connect the electronic device 100 to one or more networks.

The wireless communication unit 110 may include at least one of a broadcast receiving module 111, a mobile communication module 112, a wireless Internet module 113, a short range communication module 114, and a location information module 115.

The input unit 120 may include a camera 121 or an image input unit for inputting an image signal, a microphone 122 for inputting a sound signal, an audio input unit, or a user input unit 123 (for example, a touch key, a push key, and the like) for receiving information from a user. Voice data or image data collected by the input unit 120 may be analyzed and processed by a control command of a user.

The sensing unit 140 may include one or more sensors for detecting at least one of information in the electronic device, surrounding environment information surrounding the electronic device, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared sensor (IR sensor), a fingerprint sensor, an ultrasonic sensor, an optical sensor (e.g., see a camera 121), a microphone (see 122), a battery gauge, an environmental sensor (e.g., it may include at least one of a barometer, a hygrometer, a thermometer, a radiation detection sensor, a thermal detection sensor, a gas detection sensor, etc.), and a chemical sensor (e.g., an electronic nose, a healthcare sensor, a biometric sensor, etc.). Meanwhile, the electronic device disclosed in the present disclosure may use a combination of pieces of information detected by at least two or more of these sensors.

The output unit 150 is used to generate an output related to sight, hearing, tactile sense, or the like, and may include at least one of a display unit 151, a sound output unit 152, a haptic module 153, and an optical output unit 154. The display unit 151 forms a mutual layer structure with or is integrally formed with the touch sensor, thereby implementing a touch screen. The touch screen may function as the user input unit 123 which provides an input interface between the electronic device 100 and the user, and may provide an output interface between the electronic device 100 and the user.

The interface unit 160 serves as a path of various types of external devices connected to the electronic device 100. The interface unit 160 may include at least one of a wired/wireless headset port, an external charger port, a wired/wireless data port, a memory card port, a port for connection of a device including an identity module, an audio input/output (I/O) port, a video input/output (I/O) port, and an earphone port. In the electronic device 100, appropriate control related to the connected external device may be performed in response to the connection of the external device to the interface unit 160.

In addition, the memory 170 stores data for supporting various functions of the electronic device 100. The memory 170 may store a plurality of application programs or applications that are run by the electronic device 100, and data and instructions for operating the electronic device 100. At least some of these application programs may be downloaded from the external server via wireless communication. In addition, at least some of these application programs may be present on the electronic device 100 from the time of shipment for basic functions (for example, an incoming and outgoing call function, and a message reception and transmission function) of the electronic device 100. Meanwhile, the application program may be stored in the memory 170, installed on the electronic device 100, and run by the control unit 180 to perform the operation (or function) of the electronic device.

In addition to the operation related to the application program, the control unit 180 typically controls the overall operation of the electronic device 100. The control unit 180 may provide or process appropriate information or a function for a user by processing signals, data, information, and the like, which are input or output through the above-described components, or by running an application program stored in the memory 170.

In addition, the control unit 180 may control at least some of the components described with reference to FIG. 1 to run the application program stored in the memory 170. In addition, the control unit 180 may operate at least two or more of the components included in the electronic device 100 in combination with each other to run the application program.

The power supply unit 190 receives power from an external power source and an internal power source under the control of the control unit 180 and supply the received power to each component included in the electronic device 100. The power supply unit 190 includes a battery, which may be a built-in battery or a replaceable battery.

At least some of the components may cooperatively operate in order to implement the operation, control, or control method of the electronic device according to various embodiments described below. In addition, the operation, control, or control method of the electronic device may be implemented on the electronic device by running at least one application program stored in the memory 170.

In the present disclosure, the electronic device 100 may be collectively referred to as an electronic device.

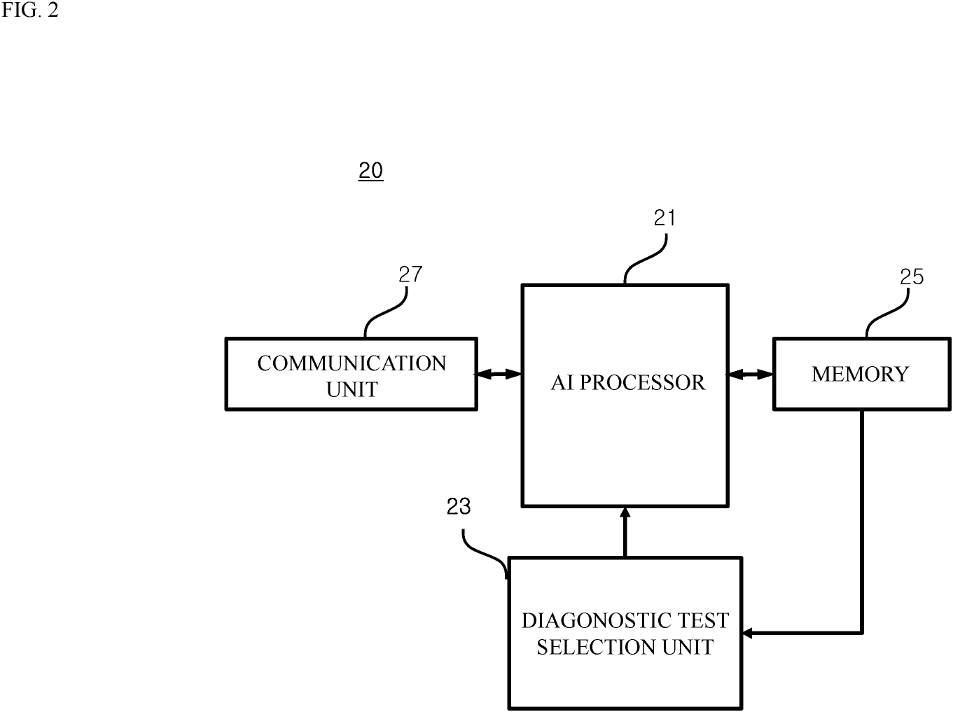

FIG. 2 is a block diagram of a system for recommending a diagnostic test to which the present disclosure may be applied.

The system 20 for recommending a diagnostic test may include an electronic device including an artificial intelligence (AI) module capable of performing AI processing, a server including the AI module, or the like. In addition, the system 20 for recommending a diagnostic test may be included as a configuration of at least a part of the electronic device 100 illustrated in FIG. 1 and may be provided to be performed in conjunction with at least some components of the electronic device 100 during AI processing.

The system 20 for recommending a diagnostic test may include an AI processor 21, a diagnostic test selection unit 23, a memory 25, and/or a communication unit 27.

The system 20 for recommending a diagnostic test is a computing device capable of learning neural networks, and may be implemented in various electronic devices such as a server, a desktop personal computer (PC), a notebook PC, and a tablet PC.

The AI processor 21 may learn the AI model using a program stored in the memory 25. In particular, the AI processor 21 may learn an AI model for performing a task of predicting a user’s score using linear regression. For example, the AI processor 21 may be trained to predict a user’s score using diagnostic test questions.

Meanwhile, the AI processor 21 for performing the functions as described above may be a general purpose processor (for example, a central processing unit (CPU)), but may be an AI dedicated processor (for example, a graphics processing unit (GPU)) for AI learning.

The diagnostic test selection unit 23 may receive an interaction matrix that may be obtained from the memory 25, and select, through knowledge tracing (KT) and Lasso regression, diagnostic test questions that are most helpful in predicting the user’s score among the obtained questions.

The memory 25 may store various programs and data necessary for the operation of the system 20 for recommending a diagnostic test. The memory 25 may be implemented by a non-volatile memory, a volatile memory, a flash memory, a hard disc drive (HDD), a solid state drive (SSD), or the like. The memory 25 is accessed by the AI processor 21, and readout/recording/correction/deletion/update, and the like, of data in the memory 25 may be performed by the AI processor 21. In addition, the memory 25 may store a neural network model (e.g., a deep learning model) generated through a learning algorithm for data classification/recognition according to an embodiment of the present disclosure.

Meanwhile, the AI processor 21 may include a data learning unit which learns a neural network for data classification/recognition. For example, the data learning unit acquires learning data to be used for learning, and applies the obtained learning data to the deep learning model, thereby making it possible to train the deep learning model.

The communication unit 27 may transmit the AI processing result by the AI processor 21 to an external electronic device.

Here, the external electronic device may include other terminals and servers.

Meanwhile, although the system 20 for recommending a diagnostic test illustrated in FIG. 2 has been described as functionally divided into the AI processor 21, the diagnostic test selection unit 23, the memory 25, the communication unit 27, and the like, the above-described components may be integrated into one module and called an AI module.

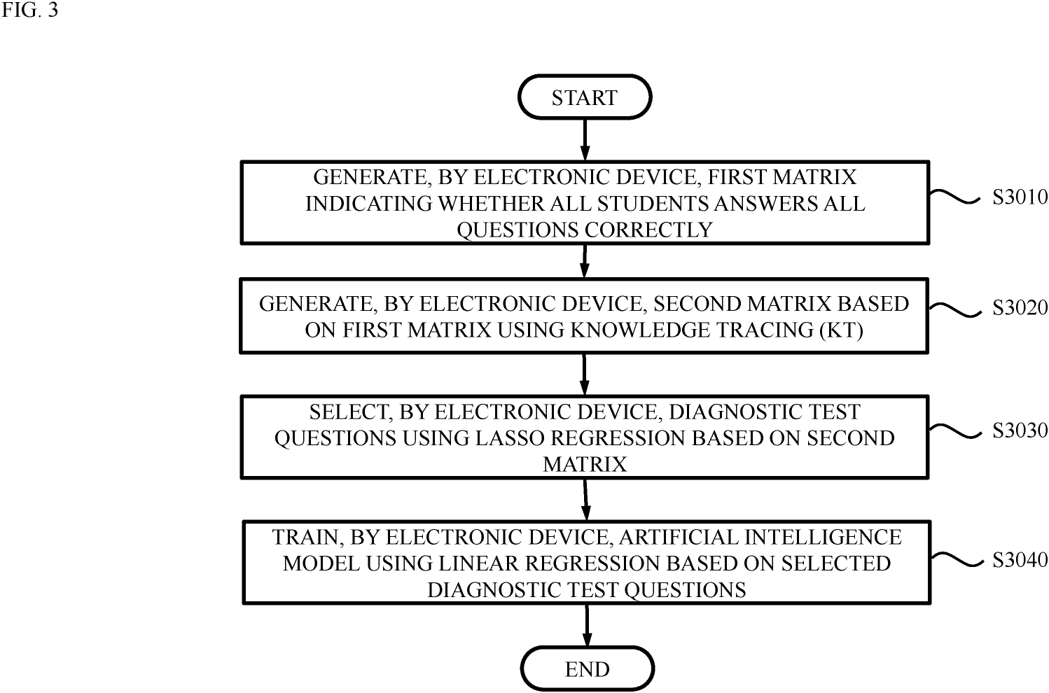

FIG. 3 illustrates an embodiment of the electronic device to which the present disclosure may be applied.

Referring to FIG. 3, the electronic device may include the configuration of the above-described system 20 for recommending a diagnostic test.

In general, in relation to a question such as a TOEIC question, when students solve a diagnostic test to predict their scores, an assessment model (AM) may predict the students’ scores by using the interaction data related to the students’ diagnostic test.

However, conventionally, a criterion for selecting diagnostic test questions is determined by an attention weight of the AM, and thus, there is insufficient verification of whether students’ scores may be predicted well using these diagnostic test questions.

In addition, the AM, which is used to predict students with the diagnostic test questions, has a problem in that it does not predict students’ scores well in the environment of diagnostic test questions with a relatively short sequence size.

In the present disclosure, the electronic device may perform an operation to solve the above problem.

Referring back to FIG. 3, the electronic device generates a first matrix (sparse interaction matrix (e.g., 8082x13435 size matrix)) indicating whether all students answer all questions correctly, with score labels stored in the memory (S3010). For example, the AI processor may generate the first matrix through the memory and store the generated first matrix in the memory.

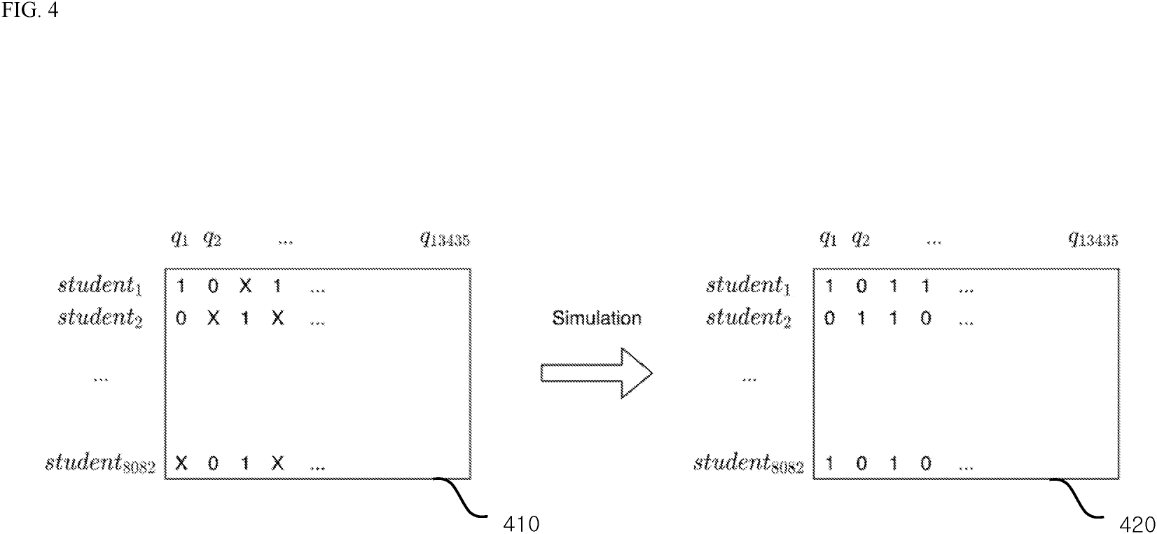

FIG. 4 illustrates an example of a sparse interaction matrix to which the present disclosure may be applied.

Referring to FIG. 4, the interaction matrix may have a value of 1 when a student answers a question correctly, and may have a value of 0 when the student answers a question incorrectly. The initial interaction matrix may have a very sparse form with a ratio of unlabeled interactions of 89% before simulation (410).

The electronic device uses KT to generate a second matrix based on the first matrix (S3020). For example, there may be no real data of 89% of interactions in the first matrix. The diagnostic test selection unit may receive the first matrix from the memory, and use all-item KT to simulate non-existent interactions for all questions for each student based on the existing interactions (for example, whether the student answers other questions related to the previous question correctly). As a result, the electronic device may generate data on whether all students answer all questions correctly, and the interaction matrix may be simulated as a fully dense matrix (420).

The electronic device selects the diagnostic test questions using Lasso regression based on the second matrix (S3030). For example, the diagnostic test selection unit may use Lasso regression to find weights and biases of the diagnostic test questions that minimize the mean squared error (MSE). Also, the electronic device may make the sum of absolute values of these weights, that is, absolute values of the weights, become a minimum (make a slope become small).

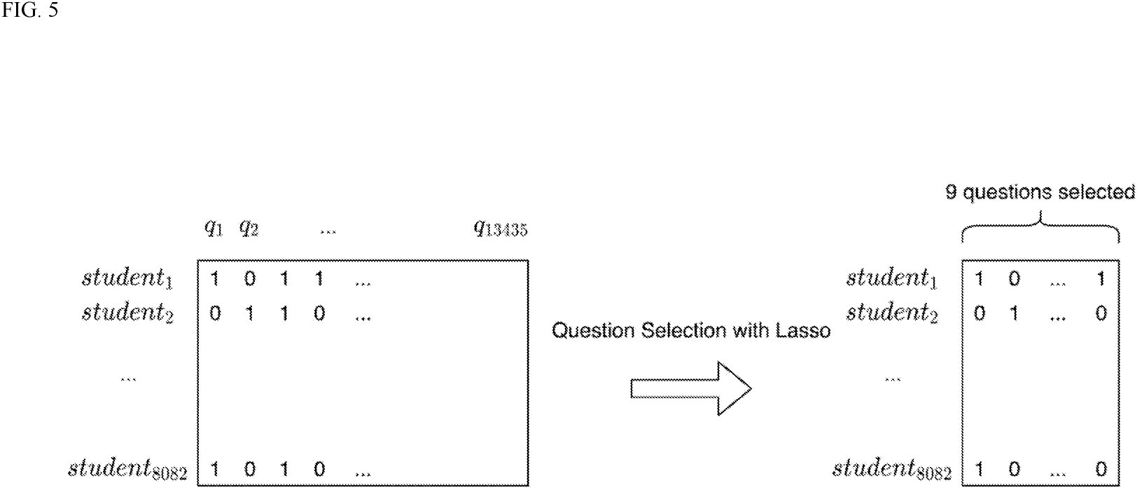

FIG. 5 illustrates an example of a question selection to which the present disclosure may be applied.

Referring to FIG. 5, the electronic device may select nine diagnostic test questions most helpful in predicting a student’s score using Lasso regression. For example, the electronic device may select nine diagnostic test questions with the highest weight when performing score prediction using Lasso regression. Here, the questions with a high weight may be the most helpful questions in predicting a student’s score.

The electronic device trains the AI model using linear regression based on the selected diagnostic test questions (S3040). For example, the AI processor may train a built-in AI model by using the diagnostic test questions as input values.

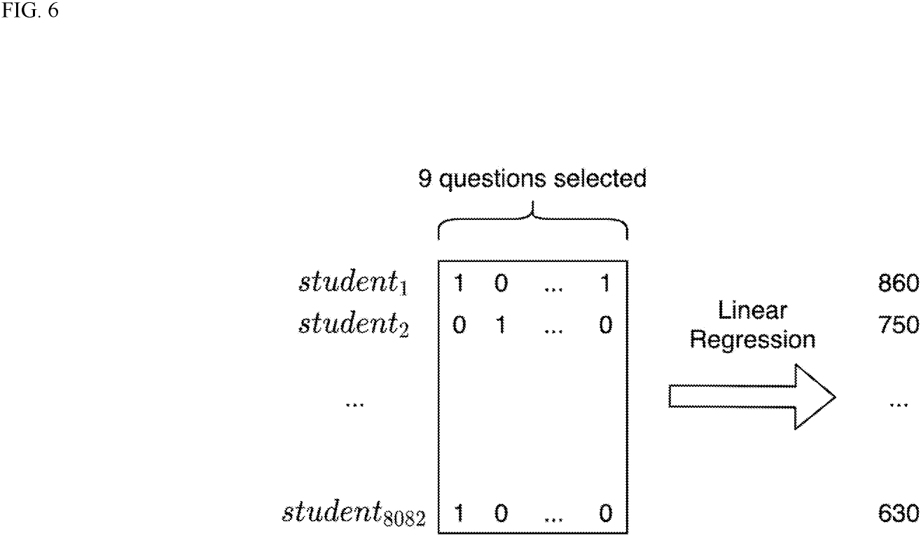

FIG. 6 illustrates an example of score prediction to which the present disclosure may be applied.

Referring to FIG. 6, the electronic device may use nine selected diagnostic test questions as input values, train an AI model using a linear regression method, and predict students’ scores using the AI model.

In addition, the electronic device may additionally use the time it takes students to solve questions as an additional weight. For example, in the case of a test with a perfect score, such as the TOEIC test, the AI model using the linear regression may not predict students’ scores as a perfect score. In order to correct this, the electronic device may additionally use the time it takes students to solve questions as an additional weight. In more detail, with respect to the time it takes students to solve the questions, the AI processor may use values obtained by averaging times taken to solve questions for each part of each problem. For example, the electronic device may calculate the ranking of the student in a set of students based on the averaged value, and use the calculated ranking as an additional weight to train the AI model.

The present disclosure described above enables the program to be embodied as computer readable code on a medium on which the program is recorded. A computer readable medium may include all kinds of recording devices in which data that may be read by a computer system is stored. An example of the computer readable medium may include a HDD, an SSD, a silicon disk drive (SDD), a read only memory (ROM), a random access memory (RAM), a compact disc-read only memory (CD-ROM), a magnetic tape, a floppy disk, an optical data storage, and the like, and also include a medium implemented in the form of a carrier wave (for example, transmission through the Internet). Therefore, the above-mentioned detailed description is to be interpreted as being illustrative rather than being restrictive in all aspects. The scope of the present disclosure should be determined by reasonable interpretation of the appended claims, and all changes within the equivalent scope of the present disclosure are included in the scope of the present disclosure.

According to an embodiment of the present disclosure, it is possible to implement a configuration for recommending a diagnostic test for evaluating students.

In addition, according to an embodiment of the present disclosure, it is possible to efficiently perform learning of an AI model for predicting students’ scores even using a small sequence size, thereby increasing the prediction accuracy of the AI model.

Effects which can be achieved by the present disclosure are not limited to the above-described effects. That is, other effects that are not described may be obviously understood by those skilled in the art to which the present disclosure pertains from the above detailed description.

In addition, although the services and embodiments have been mainly described hereinabove, this is only an example and does not limit the present disclosure. Those skilled in the art to which the present disclosure pertains may understand that several modifications and applications that are not described in the present specification may be made without departing from the spirit of the present disclosure. For example, each component described in detail in an exemplary embodiment of the present invention may be modified. In addition, differences associated with these modifications and applications are to be interpreted as being included in the scope of the present disclosure as defined by the following claims.

What is claimed is:

1. A method of recommending a diagnostic test question for user evaluation by an electronic device, the method comprising:
generating a first matrix indicating whether users answer all questions correctly;
generating a second matrix based on the first matrix using knowledge tracing (KT); and
selecting the diagnostic test question using Lasso regression based on the second matrix.

2. The method of claim 1, wherein the first matrix is a sparse matrix, and the second matrix is a dense matrix.

3. The method of claim 2, further comprising training a model for predicting a user’s score using linear regression based on the diagnostic test question.

4. The method of claim 3, further comprising correcting a model for predicting the user’s score by using a time value taken for the user to solve the questions as a weight.

5. The method of claim 4, wherein the time value is an average value of times taken to solve questions for each part of the questions.

6. The method of claim 5, wherein the time value is a ranking value of the user compared to an average value of other users based on the average value.

7. An electronic device for recommending a diagnostic test question for user evaluation, the electronic device comprising:
a communication module configured to communicate with a terminal;
a memory;
an artificial intelligence (AI) processor; and
a diagnostic test selection unit,
wherein the AI processor generates, through the memory, a first matrix indicating whether users answer all questions correctly, and
the diagnostic test selection unit uses knowledge tracing (KT) to generate a second matrix based on the first matrix, and selects the diagnostic test question using Lasso regression based on the second matrix.

8. The electronic device of claim 7, wherein the first matrix is a sparse matrix, and
the second matrix is a dense matrix.

9. The electronic device of claim 8, wherein the AI processor trains a model for predicting a user’s score using linear regression based on the diagnostic test question.

10. The electronic device of claim 9, wherein the AI processor corrects a model for predicting the user’s score by using a time value taken for the user to solve the questions as a weight.

11. The electronic device of claim 10, wherein the time value is an average value of times taken to solve questions for each part of the questions.

12. The electronic device of claim 11, wherein the time value is a ranking value of the user compared to an average value of other users based on the average value.
